(19) United States
(12) Patent Application Publication
(10) Pub. No.: US 2011/0116276 A1
(43) Pub. Date: May 19, 2011

(54) MOUNTING ASSISTING MEMBER AND LIGHTING APPARATUS

(75) Inventors: Noritaka Okamura, Osaka-shi (JP); Osamu Bando, Osaka-shi (JP)

(73) Assignee: SHARP KABUSHIKI KAISHA, Osaka-shi, Osaka (JP)

(21) Appl. No.: 13/002,140

(22) PCT Filed: Jun. 9, 2009
(86) PCT No.: PCT/JP2009/060506

§ 371 Date: Dec. 30, 2010

(30) Foreign Application Priority Data
Jul. 1, 2008 (JP) 2008-172727
Nov. 10, 2008 (JP) 2008-288013

(51) Int. Cl. F21V 21/04; F16M 13/02

(52) U.S. Cl. 362/404; 248/224.8

(57) ABSTRACT

In a mounting assisting member used for mounting a mounted body for a smaller mounting hole than a mounting hole provided in a mounting member to the mounting hole, the mounting assisting member, since support plate portions of the mounting assisting member come into surface contact with a peripheral edge portion in an upper surface side of a ceiling of a mounting hole by one surfaces. Accordingly, an influence of a concavity and convexity is lightened even in the case the concavity and convexity exists in a peripheral edge portion of the mounting hole, and a lighting apparatus for a smaller mounting hole than the mounting hole of the ceiling is stably held to the ceiling in a predetermined direction and by a predetermined support force.

This application is the national phase under 35 U.S.C. §371 of PCT International Application No. PCT/JP2009/060506 which has an International filing date of Jun. 9, 2009 and designated the United States of America.

### BACKGROUND

1. Technical Field

The present invention relates to a mounting assisting member which is used for mounting a mounted body such as a lighting apparatus or the like for a smaller mounting hole than a mounting hole to the mounting hole provided in a mounting member such as a ceiling or the like, and a lighting apparatus which is mounted to the mounting member by the mounting assisting member.

2. Description of Related Art

The apparatus such as the lighting apparatus or the like corresponding to the mounted body which is mounted to the mounting hole provided in the mounting member such as the ceiling or the like is inserted to the mounting hole, and is generally fixed to the mounting member by a mounting device such as a leaf spring or the like. There has been proposed a mounting assisting member which can be replaced by a new apparatus without any resoling construction of the mounting member such as the ceiling or the like, even at a time of newly attaching the apparatus for the smaller mounting hole than the mounting hole in the case of replacing the apparatus mentioned above (refer, for example, to Japanese Patent Application Laid-Open No. 2006-54100).

A mounting adjuster disclosed in the Japanese Patent Application Laid-Open No. 2006-54100 is provided with a collar portion which is arranged in one end opening portion of a cylindrical adjuster main body, and a plurality of mounting devices which are arranged in an outer peripheral wall of the adjuster main body and are locked onto a peripheral edge of the mounting hole in the ceiling, and is used for replacing an embedded type lighting apparatus. The mounting adjuster is structured such as to integrate the embedded type lighting apparatus and the mounting adjuster by locking a mounting device of the embedded type lighting apparatus to an inner peripheral portion of the collar portion of the mounting adjuster, and pinch the ceiling between the collar portion and the mounting device of the mounting adjuster so as to mount the embedded type lighting apparatus to the mounting hole of the ceiling, by locking the mounting device of the mounting adjuster onto the peripheral edge of the mounting hole of the ceiling.

### SUMMARY

In this case, since the ceiling is generally made of a comparatively brittle material such as a gypsum or the like, the mounting device or the tool comes into contact with the peripheral edge portion of the mounting hole of the ceiling at a time of a mounting work and a demounting work of the lighting apparatus, whereby there is a risk that a concavity and convexity is generated in the peripheral edge portion. Further, since the mounting adjuster disclosed in the patent document 1 is structured such as to support the embedded type lighting apparatus on the basis of a three point support achieved by locking three mounting devices onto the peripheral edge of the mounting hole of the ceiling, the lighting apparatus is supported in an inclined state in the case that the concavity and convexity exists in the peripheral edge portion of the mounting hole, so that a support force is concentrated on a specific position, and a dispersion is generated in the support force, whereby there is a risk that the support becomes unstable.

The present invention is made by taking the circumstances mentioned above into consideration, and an object thereof is to provide a mounting assisting member and a lighting apparatus which can stably support a mounted body for a smaller mounting hole than a mounting hole of a mounting member regardless of a state of a peripheral edge portion of the mounting hole of the mounting member.

In the mounting assisting member in accordance with the present invention, there is provided a mounting assisting member used for mounting a mounted body for a smaller mounting hole than a mounting hole provided in a mounting member to the mounting hole, the mounting assisting member comprising:

a support frame supporting the mounted body and mounted to the mounting hole,

wherein the support frame has a contact surface supporting while dispersing a support force by bringing into contact with a peripheral edge portion of the mounting hole by a plane.

In the present invention, since the contact surface coming into contact with the peripheral edge portion of the mounting hole provided in the mounting member is provided, it is possible to lighten an influence of the concavity and convexity by bringing into contact with the peripheral edge portion by the plane even in the case that the concavity and convexity exists in the peripheral edge portion of the mounting hole, whereby it is possible to stably support the mounted body for the smaller hole than the mounting hole of the mounting member to the mounting member in a predetermined direction and by a predetermined support force.

In the mounting assisting member in accordance with the present invention, the support frame is provided with a polygonal tubular base portion inscribed within the mounting hole, and is capable of mounting the mounted body for the smaller mounting hole than the mounting hole by inserting to a polygonal tube of the base portion so as to support.

In the present invention, since the polygonal tubular base portion inscribed within the mounting hole is provided, it is possible to mount the mounted body for the smaller mounting hole than the mounting hole by utilizing a difference between an inscribing circle and a circumscribing circle of the polygonal tube.

In the mounting assisting member in accordance with the present invention, the base portion has a rectangular tabular shape which is bendable at a plurality of positions in a longitudinal direction, and the support frame is structured such as to keep the base portion in the polygonal tubular shape by being inserted to the mounting hole and thereafter fixing one side in the longitudinal direction of the base portion to the other side.

In the present invention, since the base portion can be kept in the polygonal tubular shape by being inserted to the mounting hole, thereafter bending the base portion having the rectangular tabular shape capable of being bent at a plurality of positions in the longitudinal direction, and fixing one side and the other side in the longitudinal direction, it is possible to mount the support frame to the mounting hole from an inverse side to a side with which the contact surface of the support frame of the mounting hole comes into contact, for example, it is possible to mount the lighting apparatus such as a down light or the like mounted to the mounting hole of the ceiling from a lower side (a room side) of the ceiling, and it is possible to easily carry out a replacing work of the lighting apparatus.

In the mounting assisting member in accordance with the present invention, the support frame is provided with an engagement hole which is provided in the one side of the support frame, and an engagement projection which is provided in the other side and engages with the engagement hole, and the base portion is kept in the polygonal tubular shape by engaging the engagement projection with the engagement hole.

In the present invention, since the base portion is formed as the polygonal tubular shape by engaging the engagement projection provided in the other side with the engagement hole provided in the one side in the longitudinal direction of the base portion of the support frame, it is possible to form the support frame as such a shape that can be mounted to the support member without using any tool, and a workability is good.

In the mounting assisting member in accordance with the present invention, the base portion is formed as a hexagonal tubular shape.

In the present invention, since the base portion of the support frame is formed as the hexagonal tubular shape, it is possible to appropriately and stably support a so-called down light corresponding to the lighting apparatus having an approximately cylindrical shape to the mounting hole having the circular shape, for example, at a time of replacing the down light.

In the mounting assisting member in accordance with the present invention, the support frame is formed as a tabular shape having an opening to which the mounted body is attached, and is structured such as to be capable of being inserted to the mounting hole.

In the present invention, since the support frame is formed as the tabular shape, it is possible to bring the support frame into contact over an approximately whole periphery of the peripheral edge portion of the mounting hole by the plane, by appropriately forming the support frame in correspondence to the mounting hole, and it is possible to stably support the mounted body for the smaller mounting hole than the mounting hole of the mounting member on the basis of a simple structure, even in the case that the concavity and convexity exists in the peripheral edge portion of the mounting hole. Further, since the support frame can be inserted from the inverse side to the side with which the contact surface of the support frame comes into contact with the mounting hole, it is possible to mount the lighting apparatus such as the down light or the like, for example, mounted to the mounting hole of the ceiling from the lower side (the room side) of the ceiling, and it is possible to easily carry out the replacing work of the lighting apparatus. Further, since the support frame is formed as the tabular shape, it is possible to correspond even in the case that a thickness of the ceiling is small.

In the mounting assisting member in accordance with the present invention, the support frame is provided with slits in both sides sandwiching the opening therebetween.

In the present invention, since the support frame is provided with the slits in both sides sandwiching the opening therebetween, it is possible to easily bend the support frame along the slits in such a manner as to insert to the mounting hole.

In the mounting assisting member in accordance with the present invention, the support frame is provided with a concave portion in an inner peripheral end edge.

In the present invention, since the concave portion is provided in the inner peripheral end edge of the support frame, it is possible to stably support the mounted body to the mounting assisting member as well as it is possible to easily position, by engaging the mounting device provided in the mounted body with the concave portion so as to mount to the mounting hole.

In the mounting assisting member in accordance with the present invention, a cover covering a gap between the mounting hole and the mounted body is provided.

In the present invention, since the gap between the mounting hole and the mounted body is covered by the cover, it contributes to the beauty.

In the mounting assisting member in accordance with the present invention, the mounting assisting member is provided with a holding device having a contact surface coming into contact with the peripheral edge portion of the mounting hole, and an engagement plate portion provided in a rising manner in the contact surface and engaging with the support frame, and the support frame is provided with an engagement portion with which the engagement plate portion of the holding device engages.

In the present invention, since the engagement plate portion of the holding device is engaged with the engagement portion provided in the support frame from the inverse side to the side with which the contact surface of the support frame of the mounting hole provided in the mounting member comes into contact, the support frame is held in such a manner as to be prevented from coming off from the mounting hole while sandwiching the mounting member by the holding device and the support frame, and the support frame can be held in such a manner as to be prevented from coming off from the mounting hole of the mounting member at a time of mounting the mounted body to the mounting member such as the ceiling or the like. Since the support frame is fixed on the basis of the engagement, no tool is necessary, and a workability is good. Further, it is possible to hold the support frame at an appropriate position of the mounting hole by appropriately setting the engagement portion.

In the mounting assisting member in accordance with the present invention, the mounting assisting member is provided with a holding device which is provided in the cover and has an engagement plate portion engaging with the support frame, and the support frame is provided with an engagement portion with which the engagement plate portion of the holding device engages.

In the present invention, since the holding device provided in the cover is engaged with the engagement portion provided in the support frame, the support frame is held in such a manner as to be prevented from coming off from the mounting hole while sandwiching the mounting member by the support frame and the cover, and it is possible to hold in such a manner as to prevent the support frame from coming off from the mounting hole of the mounting member at a time of mounting the mounted body to the mounting member such as the ceiling or the like. Since the support frame is fixed on the basis of the engagement, no tool is necessary, and a workability is good. Further, since the cover is provided with the holding device, it is possible to prevent the holding device from being lost during the work, and the workability is improved. Further, it is possible to hold the support frame at an appropriate position of the mounting hole by appropriately providing the engagement portion.

In the mounting assisting member in accordance with the present invention, the engagement portion is constructed by a pressing piece extended in a direction of coming close to each other from two opposed sides of a rectangular hole provided in the support frame.

In the present invention, the pressing piece extended in the direction of coming close to each other from two opposed sides of the rectangular hole provided in the support frame is used as the engagement portion. Since the pressing piece is pushed up by pressing the engagement plate portion into the rectangular hole, and a force including the direction of coming close to each other of the pressing piece acts as a reaction to this force on the engagement plate portion, it is possible to securely fix the holding device and the support frame.

A lighting apparatus in accordance with the present invention is provided with the mounting assisting member as described in the invention mentioned above, and a lighting apparatus main body mounted to a mounting member such as a ceiling or the like by the mounting assisting member.

In the present invention, it is possible to stably support the lighting apparatus main body for the smaller mounting hole than the mounting hole of the mounting member regardless of a state of the peripheral edge portion of the mounting hole in the mounting member. Further, it is possible to mount the lighting apparatus main body even in the mounting hole having a larger diameter than the diameter of the lighting apparatus main body, and a general-purpose property of the lighting apparatus is improved.

In accordance with the present invention, it is possible to stably support the mounted body for the smaller mounting hole than the mounting hole of the mounting member regardless of the state of the peripheral edge portion of the mounting hole in the mounting member.

The above and further objects and features will more fully be apparent from the following detailed description with accompanying drawings.

### BRIEF DESCRIPTION OF THE DRAWINGS

FIG. 1 is an exploded perspective view of a mounting assisting member in accordance with an embodiment 1 of the present invention;

FIG. 2 is a schematic plan view of a support frame;

FIG. 3 is a partly enlarged cross sectional view along a line III-III in FIG. 2;

FIG. 4 is a schematic outer appearance perspective view of a holding device;

FIG. 5 is a schematic plan view of a cover;

FIG. 6 is a schematic cross sectional view along a line VI-VI in FIG. 5;

FIG. 7 is a schematic plan view showing a mounted state of a mounting assisting member;

FIG. 8 is a partly enlarged cross sectional view along a line VIII-VIII in FIG. 7;

FIG. 9 is an outer appearance perspective view showing a mounted state of a lighting apparatus which is mounted to a mounting hole of a ceiling by using the mounting assisting member in accordance with an Embodiment 1;

FIG. 10 is an exploded perspective view;

FIG. 11 is a schematic cross sectional view along a line XI-XI in FIG. 9;

FIG. 12 is an enlarged cross sectional view of a mounting assisting member of a lighting apparatus and a mounting portion to the ceiling;

FIG. 13 is an exploded perspective view of a mounting assisting member in accordance with an Embodiment 2 of the present invention;

FIG. 14 is a schematic plan view of a support frame;

FIG. 15 is a schematic plan view showing a mounted state of the mounting assisting member;

FIG. 16 is a partly enlarged cross sectional view along a line XVI-XVI in FIG. 15;

FIG. 17 is an outer appearance perspective view showing a mounted state of a lighting apparatus which is mounted to the mounting hole of the ceiling by using the mounting assisting member in accordance with the Embodiment 2;

FIG. 18 is a schematic plan view of a support frame of a mounting assisting member in accordance with an Embodiment 3;

FIG. 19 is a schematic outer appearance perspective view of a holding device;

FIG. 20 is a schematic plan view of a cover;

FIG. 21 is a schematic side elevational view of the cover;

FIG. 22 is a schematic plan view showing a mounted state of the mounting assisting member;

FIG. 23 is a partly enlarged cross sectional view along a line XXIII-XXIII in FIG. 22; and

FIG. 24 is a partly cross sectional enlarged view showing a mounted state of a lighting apparatus which is mounted to the mounting hole of the ceiling by using the mounting assisting member in accordance with the Embodiment 3.

### DETAILED DESCRIPTION

A description will be in detail given below of the present invention on the basis of the accompanying drawings showing its embodiments. A description will be given below by exemplifying a mounting assisting member used for mounting a lighting apparatus such as a down light or the like corresponding to a mounted body for a smaller mounting hole than a mounting hole provided in a ceiling corresponding to a mounting member, as the mounting assisting member in accordance with the present invention.

### Embodiment 1

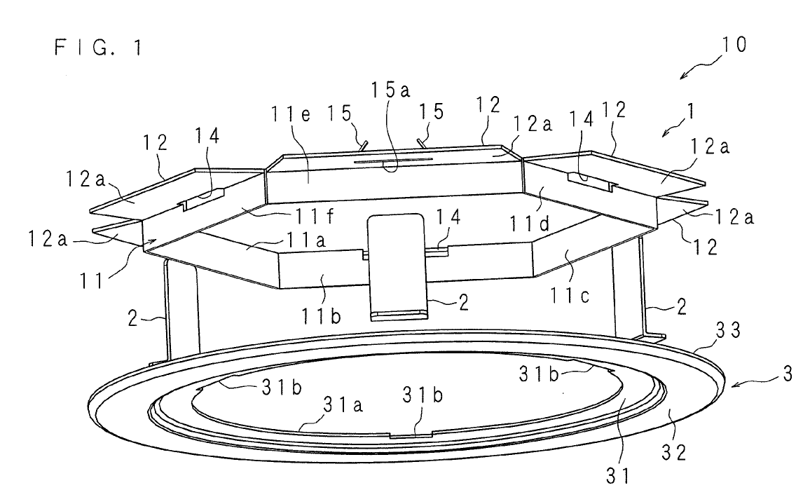

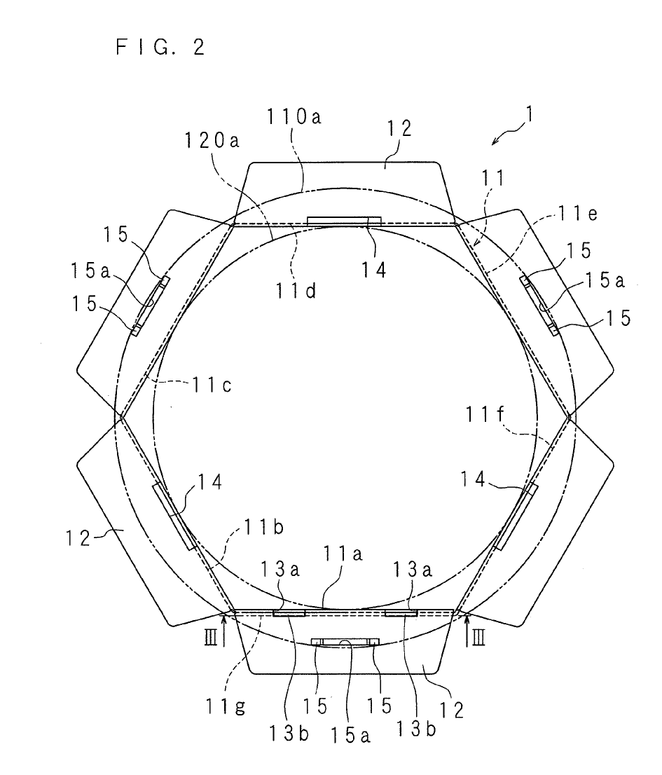

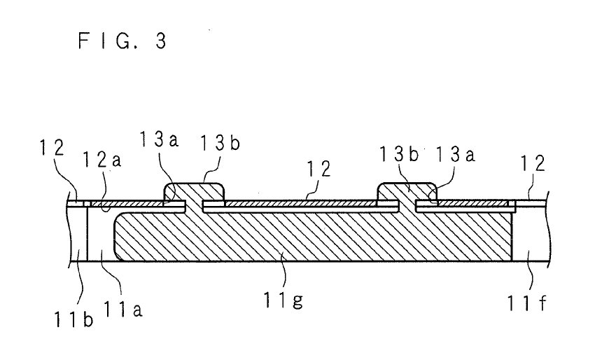

FIG. 1 is an exploded perspective view of a mounting assisting member 10 in accordance with an Embodiment 1 of the present invention. In the drawing, reference numeral 1 denotes a support frame. FIG. 2 is a schematic plan view of the support frame 1. FIG. 3 is a partly enlarged cross sectional view along a line III-III in FIG. 2. In this case, in FIG. 2, there are shown a mounting hole 110a provided in the ceiling corresponding to the mounting member and a mounting hole 120a to which the lighting apparatus main body corresponding to a mounted body should be mounted, respectively by two-dot chain lines.

The support frame 1 is provided with a hexagonal tubular base portion 11, and a plurality of (six in the drawing) support plate portions 12, 12, . . . provided in a direction which is approximately orthogonal to the base portion 11, along one side of the base portion 11, as shown in FIGS. 1 and 2.

The base portion 11 has approximately rectangular tabular seven side walls 11a, 11b, 11c, 11d, 11e, 11f and 11g, as shown in FIG. 2. Two rectangular engagement holes 13a and 13a are provided in a connection portion between the side wall 11a in one side in a longitudinal direction of the support frame 1 and the support plate portion 12 thereof so as to be isolated at an appropriate length along the connection portion. The side wall 11g in the other side of the support frame 1 has a smaller rectangular shape than the other six side walls 11a, 11b, 11c, 11d, 11e and 11f. The side wall 11g is provided with two engagement projections 13b and 13b extending in a width direction from one side along a longitudinal direction of the side wall 11g so as to be isolated at an appropriate length, as shown in FIG. 3. The support frame 1 is structured, as shown in FIG. 3, such as to hold the base portion 11 in a hexagonal tubular shape by engaging the engagement projections 13b and 13b with the engagement holes 13a and 13a in a state in which the side wall 11g in the other side is lapped over the side wall 11a in the one side of the support frame 1.

A plurality of concave portions 14, 14, . . . are provided in a connection portion between the base portion 11 corresponding to an inner peripheral edge of the support frame 1 and the support plate portion 12 so as to be three uniformly arranged. A leaf spring corresponding to a mounting device of a mounted body mentioned below is brought into contact with the concave portions 14, 14, . . . .

The support plate portions 12, 12, . . . are formed as a trapezoidal shape having a bottom side which is approximately equal to a length in the longitudinal direction of the side walls 11a, 11b, 11c, 11d, 11e and 11f, as shown in FIG. 2, and one surface (the contact surface) 12a, 12a, . . . close to the side of the base portion 11 are formed as a flat surface in order to bring into contact with a peripheral edge portion in one side of a mounting hole 110a provided in the mounting member, as mentioned below. Pressing pieces 15, 15, . . . corresponding to an engagement portion are provided respectively in approximately the center of every other support plate portions 12, 12, . . . . The pressing pieces 15, 15, . . . are extended in a direction coming close to each other from two opposed sides of rectangular holes 15a, 15a, . . . provided approximately in the center of the support plate portions 12, 12, . . . . The pressing piece 15 is formed, for example, by notching approximately the center of the support plate portion 12 as an approximately H-shaped form, and bending a cut-out rectangular plate piece. In this case, the support plate portions 12, 12, . . . provided with the concave portions 14, 14, . . . and the support plate portions 12, 12, . . . provided with the pressing pieces 15, 15, . . . are alternately arranged.

The support frame 1 is made, for example, of a metal, and is formed as the shape mentioned above by cutting out a solid plate into a predetermined shape by a laser beam, thereafter bending in such a manner that the base plate 11 and the support plate portion 12 form approximately vertical, and bending the base portion 11 at a plurality of positions in the longitudinal direction. In this case, the support frame 1 is not limited to being made of the metal, but a processing method is not limited to a cutting process.

The support frame 1 as mentioned above is appropriately set in correspondence to the diameter of the mounting hole 110a provided in the mounting member and that of the mounting hole 120a to which the mounted body should be mounted, which are shown by the two-dot chain line in FIG. 2. The base portion 11 is decided in such a manner that it approximately is inscribed within the mounting hole 110a, and approximately is circumscribed with the mounting hole 120a to which the lighting apparatus main body corresponding to the mounted body should be mounted, and an outer dimension becomes smaller than the mounting hole 110a. The support plate portions 12, 12, . . . are decided in such a manner that they can come into contact with the peripheral edge portion of the mounting hole 110a, and the rectangular holes 15a, 15a, . . . provided in the support plate portions 12, 12, . . . are positioned inside the mounting holes 110a. It is preferable that the rectangular holes 15a, 15a, . . . are structured such as to be inscribed within the mounting hole 110a. Accordingly, it is possible to hold the support frame 1 at an appropriate position of the mounting hole 110a, that is, concentrically with the mounting hole 110a.

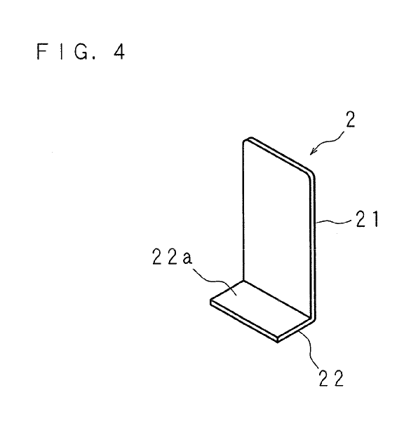

The holding devices 2, 2, . . . are engaged with the pressing pieces 15, 15, . . . of the support frame 1 in order to hold the support frame 1 to the mounting member. FIG. 4 is a schematic outer appearance perspective view of the holding device 2. The holding device 2 is provided with an engagement plate portion 21 engaging with the pressing pieces 15 and 15, and an extension portion 22 extended from one end of the engagement plate portion 21 in an orthogonal direction, and has an approximately L-shaped form. One surface 22a (a surface close to the engagement plate portion 21) corresponding to a contact surface of the extension portion 22 is formed as a flat surface in order to be brought into contact with the peripheral edge portion in the other side of the mounting hole, as mentioned below. In this case, a length of the engagement plate portion 21 is decided in such a manner as to be larger than a thickness of the mounting member. For example, in the case that a range between 5 and 25 (mm) is assumed as a thickness of the ceiling corresponding to the mounting member, the length of the engagement plate portion 21 is set, for example, to 30 (mm) which is larger than 25 (mm).

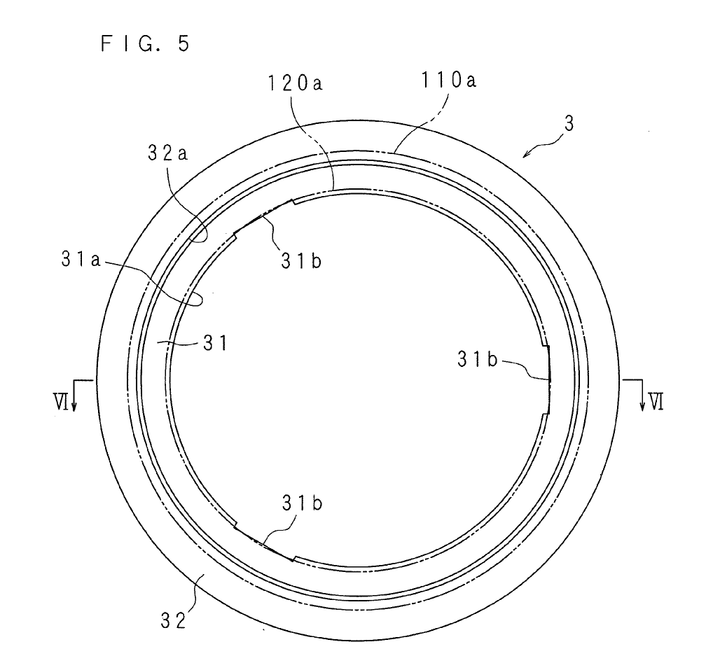

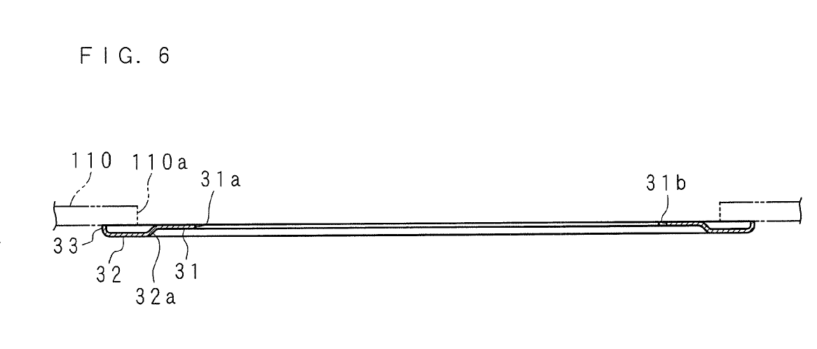

The mounting assisting member 10 is provided with the cover 3 which should cover a gap between the mounting hole 110a provided in the mounting member and the mounted body. FIG. 5 is a schematic plan view of the cover 3. FIG. 6 is a schematic cross sectional view along a line VI-VI in FIG. 5. In this case, the mounting hole 110a provided in the mounting member and the mounting hole 120a to which the mounted body should be mounted are shown respectively by two-dot chain lines. Further, in FIG. 6, the ceiling 110 corresponding to the mounting member and the mounting hole 110a provided in the ceiling 110 are shown respectively by two-dot chain lines.

The cover 3 is provided with a disc portion 31 having a circular opening 31a in the center, an annular portion 32 extended over a whole periphery in a radial direction from an outer peripheral edge of the disc portion 31, and a protruding portion 33 provided in an outer peripheral edge of the annular portion 32 in a rising manner over a whole periphery.

An inner peripheral edge of the disc portion 31 is provided with rectangular notches 31b, 31b, . . . so as to be three uniformly arranged in a peripheral direction. In this case, the notches 31b, 31b, . . . are decided in correspondence to a shape of the mounting device of the mounted body.

The annular portion 32 is formed as a tabular shape which is approximately in parallel to the disc portion 31, and is structured such as to have a larger diameter than a diameter of the mounting hole 110a provided in the ceiling 110 corresponding to the mounting member, which is shown by a two-dot chain line in the drawing. A connection portion 32a between the annular portion 32 and the disc portion 31 is inclined gently. Accordingly, it is possible to make a boundary portion between the cover 3 and the mounted body inconspicuous at a time of bringing the mounted body into contact with the disc portion 31. In this case, a width of the annular portion 32 is decided appropriately in such a manner that the annular portion 32 covers the mounting member over an appropriate length in a radial direction from a peripheral edge end of the mounting hole 110a.

The protruding portion 33 is provided in a rising manner in the side of the disc portion 31 in an outer peripheral edge of the annular portion 32, and an end portion of the protruding portion 33 is set approximately flush with respect to the disc portion 31. On the basis of this protruding portion 33, as shown in FIG. 6, the annular portion 32 is opposed to the peripheral edge portion of the mounting hole 110a provided in the mounting member so as to be isolated. In this case, a height of the protruding portion 33 is made larger than a thickness of the extending portion 22 of the holding devices 2, 2, . . . mentioned above.

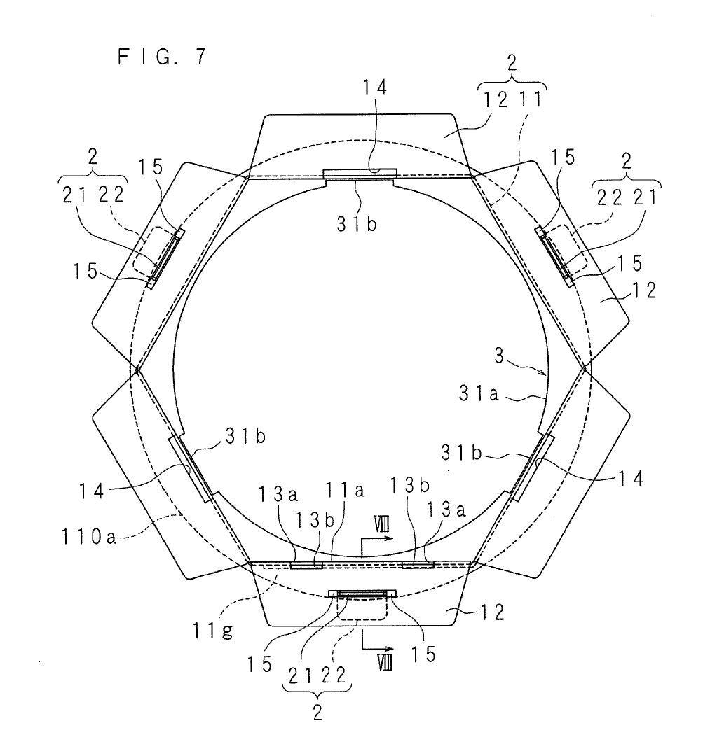

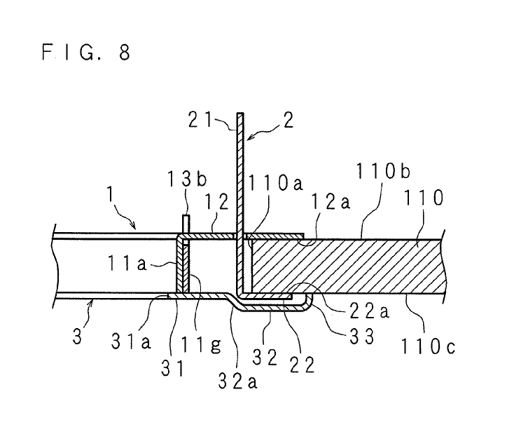

The mounting assisting member 10 structured as mentioned above is mounted to the mounting hole 110a provided in the ceiling 110 corresponding to the mounting member. FIG. 7 is a schematic plan view showing a mounted state of the mounting assisting member 10. FIG. 8 is a partly enlarged cross sectional view along a line VIII-VIII in FIG. 7.

The support frame 1 is inserted to the mounting hole 110a provided in the ceiling 110 from the other end side (the side of the lower surface 110c of the ceiling 110) in a state in which an engagement between the engagement holes 13a and 13a and the engagement projections 13b and 13b is released, thereafter engaging the engagement projections 13b and 13b with the engagement holes 13a and 13a, and bringing the one surfaces 12a, 12a, . . . corresponding to the contact surfaces of the support plate portions 12, 12, . . . into contact with the peripheral edge portion of the one end side of the mounting hole 110a (the side of the upper surface 110b of the ceiling 110), thereby being supported to the mounting holes 110a.

In a state in which the support frame 1 is supported to the mounting hole 110a, the holding device 2, 2, . . . are pressed into the rectangular holes 15a, 15a, . . . of the support frame 1 from the side of the lower surface 110c of the ceiling 110 while setting the engagement plate portions 21, 21, . . . to the upper side. Accordingly, the pressing pieces 15, 15, . . . are pushed up, and are deformed by being applied a force in such a direction as to separate from each other. A force including a direction coming close to each other of the pressing pieces 15, 15, . . . is applied as a reaction to the engagement plate portions 21, 21, . . . from the pressing pieces 15, 15, . . . , and the pressing pieces 15, 15, . . . and the engagement plate portions 21, 21, . . . are engaged. As a result, the ceiling 110 is pinched by the holding devices 2, 2, . . . and the support frame 1, and the support frame 1 is supported in such a manner as to prevent from coming off from the mounting hole 110a.

In this state, even if a force pulling the extending portion 22 of the holding device 2 downward is applied, the engagement between the pressing piece 15 and the engagement plate portion 21 of the holding device 2 is not released. In this case, as mentioned below, the holding device 2 may be taken out below while opening the pressing piece 15 in such a manner as to suppress a catch, by putting a hand from the mounting hole (the hexagonal tube) at a time of detaching.

On the other hand, the cover 3 is previously fitted to the mounted body. When the mounted body is mounted to the support frame 1 while being inserted an inner side of the hexagonal tubular base portion 11 of the support frame 1, the cover 3 is brought into contact with the lower surface 110c of the ceiling 110 by the protruding portion 33, as shown in FIG. 8.

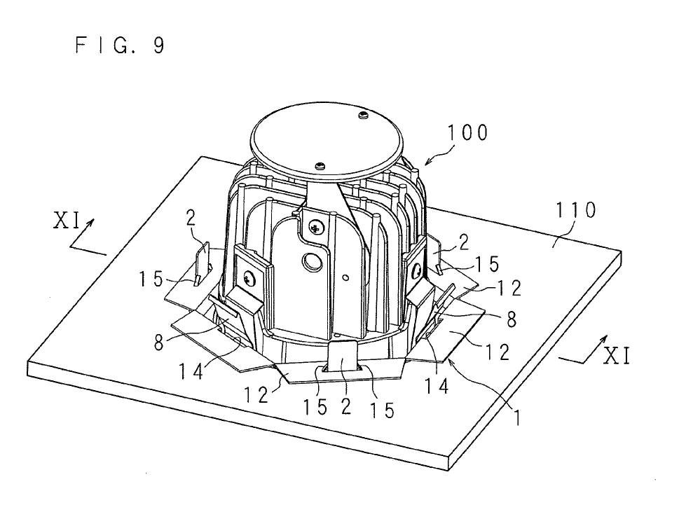

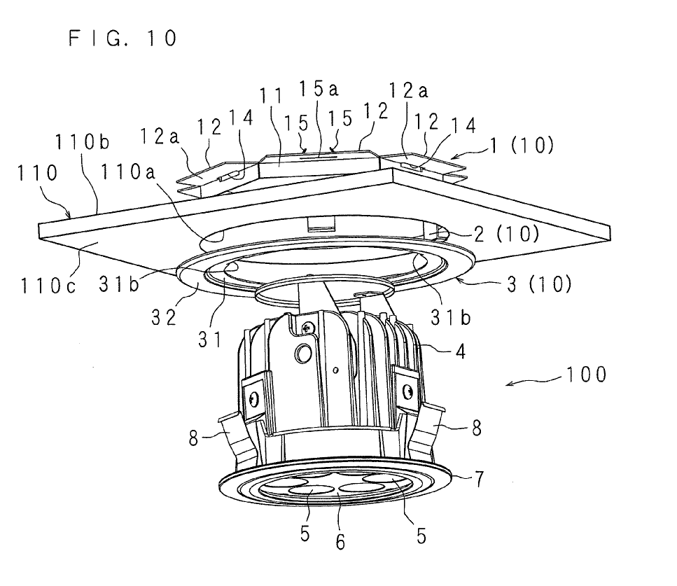

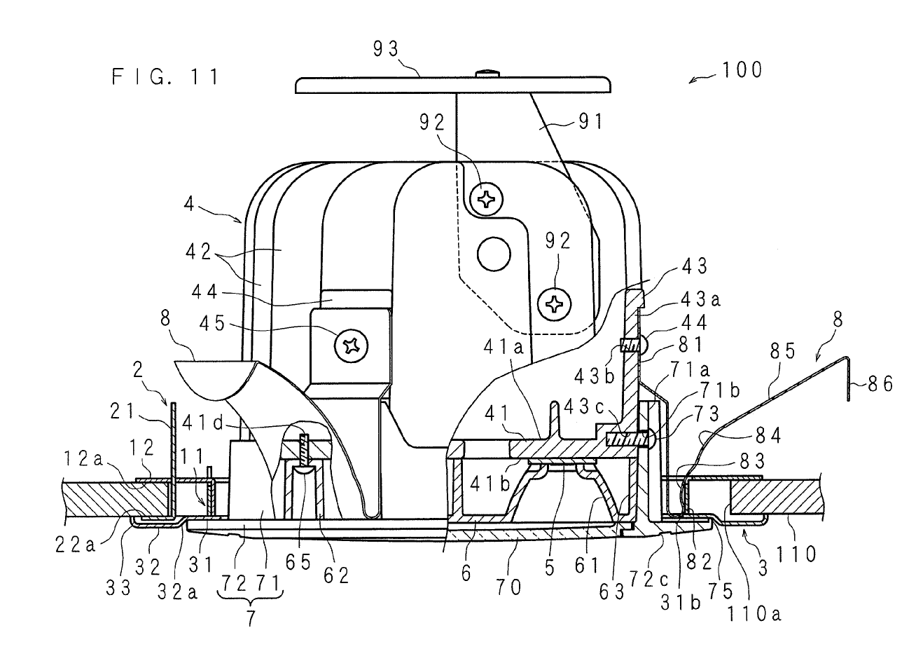

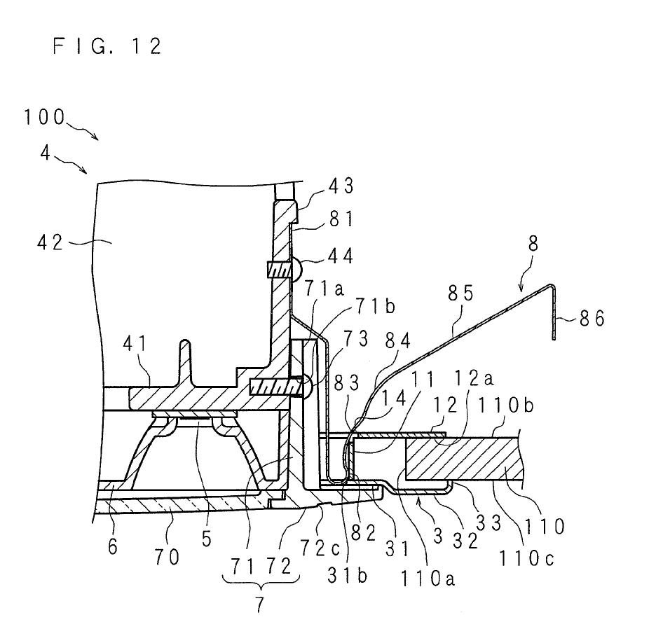

The mounting assisting member 10 is used in order to mount the lighting apparatus such as the down light or the like having an outside dimension which is suitable for the smaller mounting hole 120a than the mounting hole 110a provided in the ceiling 110. FIG. 9 is an outer appearance perspective view showing a mounted state of the lighting apparatus 100 attached to the mounting hole 110a of the ceiling 110 by using the mounting assisting member 10 in accordance with the Embodiment 1, and FIG. 10 is an exploded perspective view. FIG. 11 is a schematic cross sectional view along a line XI-XI in FIG. 9. In this case, in FIG. 11, as a matter of convenience for explanation, the lighting apparatus 100 is shown by a side elevational view showing a part thereof by a partial cross section. FIG. 12 is an enlarged cross sectional view of a mounting portion of the lighting apparatus 100 in FIG. 11 to the mounting assisting member 10 and the ceiling 110.

In the drawing, reference numeral 4 denotes a radiator 4 made of a metal such as an aluminum or the like. The radiator 4 has an approximately disc-like heat transfer plate 41, as shown in FIG. 11. A plurality of rectangular tabular radiator plates 42, 42, . . . are provided in a rising manner in one surface 41a of the heat transfer plate 41 so as to form parallel, and a connection plate (not shown) is provided in a rising manner in such a manner as to pass through approximately the center of a plurality of radiator plates 42, 42, . . . and be orthogonal to a plurality of radiator plates 42, 42, . . . .

A plurality of thread holes 41d, 41d, . . . are provided in a peripheral edge portion of the heat transfer plate 41. Further, rectangular tabular fixing portions 43, 43, . . . are provided in a peripheral edge portion of the heat transfer plate 41 in the radiator 4 so as to be three uniformly arranged in such a manner as to be orthogonal to a radial direction of the heat transfer plate 41. The fixing portions 43, 43, . . . are respectively connected to a plurality of radiator plates 42, 42, . . . so as to be integrally constructed, and are arranged in such a manner that one fixing portion 43 is connected so as to be perpendicular to the radiator plates 42, 42, . . . . Outer surfaces 43a, 43a, . . . of the fixing portions 43, 43, . . . are formed as a flat surface, and thread holes 43b and 43c are provided up and down in line in the fixing portion 43. In this case, the radiator 4 may be integrally formed by a die casting, or may be formed by an extrusion work or a cutting work.

A plurality of (six in the drawing) LED modules 5, 5, . . . serving as a light source are mounted to the other surface 41b of the heat transfer plate 41 of the radiator 4 so as to be uniformed arranged in a peripheral direction. The LED module 5 is constructed by sealing a plurality of LED elements densely mounted to the center portion of one surface of a rectangular ceramic (for example, an aluminum oxide) substrate by a sealing resin in which a fluorescent material is dispersed. In this case, a heat transfer sheet or a grease is interposed between the LED modules 5, 5, . . . and the heat transfer plate 41. A heat generated in the LED modules 5, 5, . . . in accordance with a lighting of the LED modules 5, 5, . . . is transferred to the heat transfer plate 41, the radiator plates 42, 42, . . . and the connection plate, and is dispersed to an external portion on the basis of a natural convection.

A reflection plate 6 is provided in the side of the other surface 41b of the heat transfer plate 41 in the radiator 4. In the reflection plate 6, a plurality of reflection portions 61, 61, . . . having an approximately semispherical concave portion are formed at positions corresponding to the LED modules 5, 5, . . . at a time of mounting the reflection plate 6 to the radiator 4, in such a manner as to surround the LED modules 5, 5, . . . .

The reflection plate 6 is provided with approximately cylindrical concave portions 62, 62, . . . at positions corresponding to the thread holes 41d, 41d, . . . provided in the heat transfer plate 41 at a time of mounting the reflection plate 6 to the radiator 4. Further, a peripheral wall 63 is provided in a rising manner in a peripheral edge of the reflection plate 6. The reflection plate 6 is fixed to the radiator 4 by bringing an end surface of the peripheral wall 63 into contact with the heat transfer plate 41, inserting screws 65, 65, . . . to through holes provided in the concave portions 62, 62, . . . of the reflection plate 6, and engaging with the thread holes 41d, 41d, . . . provided in the heat transfer plate 41. A light from the LED modules 5, 5, . . . is reflected by the reflection portions 61, 61, . . . of the reflection plate 6, and is included in such a range that an angle formed with respect to an optical axis of the LED modules 5, 5, . . . becomes equal to or less than a predetermined angle, and the light in which a light distribution characteristic is controlled such that an illumination intensity just below the lighting apparatus 100 becomes strong is emitted from the lighting apparatus 100.

A frame 7 is provided in a side of the heat transfer plate 41 of the radiator 4. The frame 7 has a cylinder portion 71, and an annular collar portion 72 which is extended in a radial direction from one end of the cylinder portion 71 to an orthogonal direction. The cylinder portion 71 is provided with extension portions 71a, 71a, . . . extended from three positions in a peripheral direction to an inverse side to the collar portion 72, and the extension portions 71a, 71a, . . . are provided with through holes 71b, 71b, . . . . In this case, the through holes 71b, 71b, . . . are provided respectively at positions corresponding to the thread holes 43c, 43c, . . . provided in the fixing portions 43, 43, . . . of the radiator 4 at a time of mounting the frame 7 to the radiator 4.

The collar portion 72 is provided concentrically with an annular groove 72c having approximately the same diameter as the cylinder portion 71. This is because of making a shrink mark corresponding to a concavity generated by a difference in speed at which a molten resin is cured in correspondence to a thickness inconspicuous even if the shrink mark is generated at a time of manufacturing the frame 7 in accordance with an injection molding. Further, an outer peripheral edge of the collar portion 72 is provided with a protruding portion 75 which is arranged in a rising manner over a whole periphery so as to be in parallel to the cylinder portion 71.

The frame 7 is fixed to the radiator 4 by inward fitting the reflection plate 6 to the other end side of the cylinder 71, inserting screws 73, 73, . . . to the through holes 71b, 71b, . . . in a state in which the extension portions 71a, 71a, . . . are brought into contact with the outer surfaces 43a, 43a, . . . of the fixing portions 43, 43, . . . of the radiator 4, and engaging with the thread holes 43c, 43c, . . . . A disc-like resin transmission plate 70 is mounted to an inner surface of the collar portion 72 of the frame 7 in such a manner as to cover the LED modules 5, 5, . . . . The transmission plate 70 is made, for example, of a polycarbonate resin.

Further, a plurality of leaf springs 8, 8, . . . are provided in the radiator 4. The leaf spring 8 is made of a metal such as a stainless steel or the like, and is formed as a V-shaped form as shown in FIG. 11, by bending an elongated rectangular plate. A rectangular tabular fixing portion 81 is provided in one side of the leaf spring 8, and the other side of the leaf spring 8 sandwiching a bent portion 82 therebetween is provided continuously with a first pressing portion 83 and a second pressing portion 84 which are curved as a convex shape to a side of the fixing portion 81, and having a circular arc cross sectional shape along a longitudinal direction of the leaf spring 8. Further, the other side end portion of the leaf spring 8 is provided with a come-off preventing portion 86 which is bent to an inverse side to the fixing portion 81 at an angle from an end portion of an arm portion 85 connected to the second pressing portion 84 to the arm portion 85.

The leaf springs 8, 8, . . . mentioned above are fixed to the radiator 4 so as to be three uniformed arranged in the peripheral direction in a state in which the fixing portions 81, 81, . . . of the leaf springs 8, 8, . . . are closely attached to the outer surfaces 43a, 43a, . . . of the fixing portions 43, 43, . . . , by inserting the screws 44, 44, . . . to the through holes provided in the fixing portions 81, 81, . . . of the leaf springs 8, 8, . . . , and engaging with the thread holes 43b, 43b, . . . provided in the fixing portions 43, 43, . . . of the radiator 4.

Mounting plates 91 and 91 are fixed to the radiator plates 42 and 42 which are the second from the outer side of the radiator 4 by screws 92, 92, . . . so as to be in parallel to the radiator plates 42 and 42. A disc 93 is attached to an upper portion of the mounting plates 91 and 91 so as to be vertical to the mounting plates 91 and 91. The disc 93 is provided for preventing a foreign material such as a dust or the like from entering into the lighting apparatus 100, particularly between the radiator plates 42, 42, . . . .

In the case that the lighting apparatus 100 mentioned above is mounted to the mounting hole 110a having a larger diameter than a diameter of a mounting hole which is appropriate for the lighting apparatus 100 (for example, the case that the lighting apparatus 100 has an outside dimension which is appropriate for a mounting hole having a diameter 125 mm, and a diameter of the mounting hole 110a provided in the ceiling 110 to which the lighting apparatus 100 is newly mounted is 150 mm), the mounting assisting member 10 in accordance with the Embodiment 1 is used.

The support frame 1 of the mounting assisting member 10 is mounted to the mounting hole 110a in such a manner that the support frame 1 does not come off from the mounting hole 110a by the holding devices 2, 2, . . . in a state in which the support frame 1 of the mounting assisting member 10 brings the one surfaces 12a, 12a, . . . of the support plate portions 12, 12, . . . of the support frame 1 into contact with the peripheral edge portion of one end side of the mounting hole 110a (a side of the upper surface 110b of the ceiling 110), as mentioned above.

On the other hand, the cover 3 of the mounting assisting member 10 is previously fitted between the leaf springs 8, 8, . . . of the lighting apparatus 100 and the collar portion 72 of the frame 7. This fitting is achieved by inserting the cover 3 from the side of the radiator 4 of the lighting apparatus 100 in a state in which the leaf springs 8, 8, . . . of the lighting apparatus 100 are pressed to the side of the radiator 4. In this case, the cover 3 is mounted to the lighting apparatus 100 in such a manner that the notches 31b, 31b, . . . provided in the disc portion 31 of the cover 3 come into line with the leaf springs 8, 8, . . . in their positions in the peripheral direction.

In this state, the lighting apparatus 100 is fixed to the mounting hole 110a of the ceiling 110 via the mounting assisting member 10, as shown in the drawing, by inserting to the base portion 11 of the support frame 1 supported by the mounting hole 110a from the other end side of the mounting hole 110a (the side of the lower surface 110c of the ceiling 110) in a state in which the leaf springs 8, 8, . . . are pressed to the side of the radiator 4, and further pressing the lighting apparatus 100 after unlinking hands from the leaf springs 8, 8, . . . . At this time, as shown in FIG. 9, the lighting apparatus 100 is mounted to the mounting assisting member 10 in such a manner that the concave portions 14, 14, . . . provided in the support frame 1 coincide with the leaf springs 8, 8, . . . in their positions in the peripheral direction.

Describing in more detail, when the leaf spring 8 which is pressed to the side of the radiator 4 at a time of mounting to the concave portions 14, 14, . . . of the support frame 1 and is elastically deformed is going to turn back to the natural state in accordance with the release of the pressing force, the first pressing portion 83 of the leaf spring 8 comes into contact with the concave portion 14 in the middle of the circular arc from a diagonally upper side, as shown in FIGS. 11 and 12. Accordingly, as well as a component force in a downward direction corresponding to a vertical direction acts on an installation surface of the ceiling 110 and the upper surface 110b of the ceiling 110 is pressed in a downward direction by the first pressing portion 83 via the support plate portion 12 of the support frame 1 brought into contact with the upper surface 110b, a component force in an upward direction acts on the lighting apparatus 100 and the lower surface 110c of the ceiling 110 is pressed in an upward direction by the collar portion 72 of the frame 7 via the protrusion portion 33 of the cover 3. As a result, the lighting apparatus 100 is stably fixed to the ceiling 110 in a state in which the ceiling 110 is sandwiched by the support plate portion 12 of the support frame 1 and the cover 3.

Here, in the case of demounting the mounting assisting member 10, the leaf springs 8, 8, . . . come off partway by first of all breaking open the portion with respect to the frame 7 from the connection portion 32a between the annular portion 32 of the cover 3 and the disc portion 31 thereof, and pulling down the frame 7 downward by putting a finger on the open gap. Next, the lighting apparatus 100 can be demounted together with the cover 3 by slowly taking out of the mounting hole 110a while bringing down the leaf springs 8, 8, . . . toward the radiator 4. In order to demount the support frame 1, it can be taken out of the mounting hole by drawing out the holding device 2 while slightly opening in such a manner as to prevent the pressing piece 15 from being eaten into, and detaching the engagement projection 13b from the engagement hole 13a so as to open the hexagonal tube of the support frame 1.

Since the support plate portions 12, 12, . . . of the mounting assisting member 10 come into surface contact with the peripheral edge portion close to the upper surface 110b of the ceiling 110 of the mounting hole 110a by the one surfaces 12a, 12a, . . . as mentioned above, it is possible to lighten the influence of the concavity and convexity even in the case that the concavity and convexity exists in the peripheral edge portion of the mounting hole 110a, and it is possible to stably support the lighting apparatus 100 for the smaller mounting hole 120a than the mounting hole 110a of the ceiling 110 to the ceiling 110 in a predetermined direction and by a predetermined support force.

Further, since six support plate portions 12, 12, . . . which are approximately vertical to the hexagonal tubular base portion 11 are brought into contact with the peripheral edge portion close to the upper surface 110b side of the ceiling 110 of the mounting hole 110a by the one surfaces 12a, 12a, . . . , it is possible to uniformly bring the support plate portions 12, 12, . . . into surface contact with the peripheral edge portion of the mounting hole 110a so as to be approximately arranged uniformly, so that it is possible to stably support the lighting apparatus 100 for the smaller mounting hole 120a than the mounting hole 110a of the ceiling 110 even in the case that the concavity and convexity exists in the peripheral edge portion of the mounting hole 110a and the case that the strength is lowered.

Further, since the concave portions 14, 14, . . . are provided in the inner peripheral end edge of the support frame 1, it is possible to easily position by engaging the leaf springs 8, 8, . . . provided in the lighting apparatus 100 so as to be mounted to the mounting hole 110a with the concave portions 14, 14, . . . , and it is possible to stably support the lighting apparatus 100 to the mounting assisting member 10.

In the case that the ceiling 110 corresponding to the mounting member is made of a comparatively brittle material such as a gypsum or the like, the force applied to the ceiling 110 from the lighting apparatus 100 acts on the peripheral edge portion of the mounting hole 110a via the mounting assisting member 10 in a dispersed manner by using the mounting assisting member 10 constructed as mentioned above. Accordingly, it is possible to prevent the mounting hole 110a from being damaged, and it is possible to use the mounting assisting member 10 as the reinforcing member of the mounting hole 110a.

Further, as mentioned above, since it is structured, as mentioned above, such that it can be inserted to the mounting hole 110a from the lower surface 110c of the ceiling 110, it is possible to easily carry out a replacing work of the lighting apparatus 100.

Since the base portion 11 is formed as the polygonal tubular shape by engaging the engagement projections 13b and 13b provided in the other side (the side of the side wall 11g) with the engagement holes 13a and 13a provided in the one side (the side of the side wall 11a) in the longitudinal direction of the base portion 11 of the support frame 1, it is possible to form the support frame 1 as a shape which can be mounted to the ceiling 110, and a workability is good.

Since the engagement plate portion 21 of the holding devices 2, 2, . . . is engaged with the pressing pieces 15, 15, . . . provided in the support frame 1 from the side of the lower surface 110c of the ceiling 110 of the mounting hole 110a provided in the ceiling 110, it is possible to hold in such a manner as to prevent the support frame 1 from coming off from the mounting hole 110a by sandwiching the ceiling 110 by the holding devices 2, 2, . . . and the support frame 1. Accordingly, it is possible to prevent the support frame 1 from coming off from the mounting hole 110a to the back side of the ceiling 110 at a time of mounting the lighting apparatus 100 to the ceiling 110. Since the support frame 1 is fixed on the basis of an engagement, any tool is not necessary, and a workability is good.

Further, since a gap between the mounting hole 110a and the lighting apparatus 100 is covered by the cover 3, it contributes to the beauty.

In this case, in the present embodiment, the base portion 11 of the support frame 1 is formed as a hexagonal tubular shape, however, it is not limited to this, but may be formed as a polygonal shape. In other words, it is possible to mount the mounted body for the smaller mounting hole than the mounting hole to the mounting hole by using the polygonal tubular base portion, thereby utilizing a difference between a diameter of an inscribing circle and a diameter of a circumscribing circle in the polygonal tube. Further, various combinations of the mounting holes having different diameters and the mounting bodies can be achieved by constructing the bent structure of the base portion in such a manner that plural kinds of polygonal tubes can be selected.

Further, the present embodiment is structured such that the engagement holes 13a and 13a and the engagement projections 13b and 13b are engaged in such a manner as to hold the base portion 11 of the support frame 1 in the hexagonal tubular shape, however, the structure is not limited to this, but may be made such as to have the other engaging means, or may be made such as to fix by a fixing device such as a screw or the like.

Further, the present embodiment is structured such that the holding device 2 and the pressing pieces 15, 15, . . . provided in the support frame 1 are engaged in such a manner as to support the support frame 1 so as to prevent from coming off from the mounting hole 110a to the back side of the ceiling 110, however, the structure is not limited to this, but may be made such as to have the other engaging means, or may be made such as to fix to the ceiling 110 by a fixing device such as a screw or the like.

### Embodiment 2

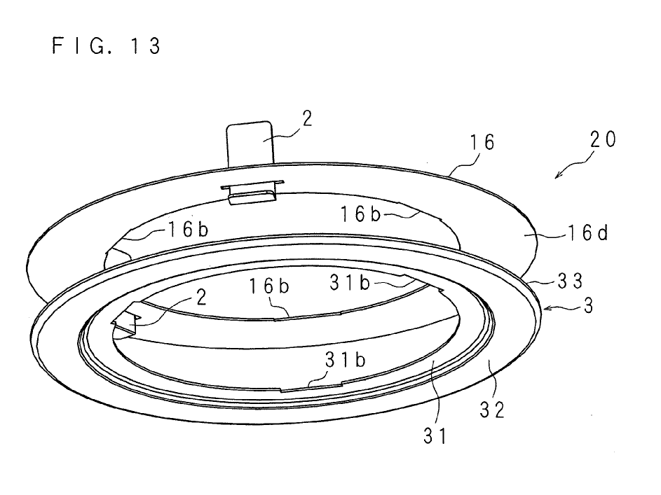

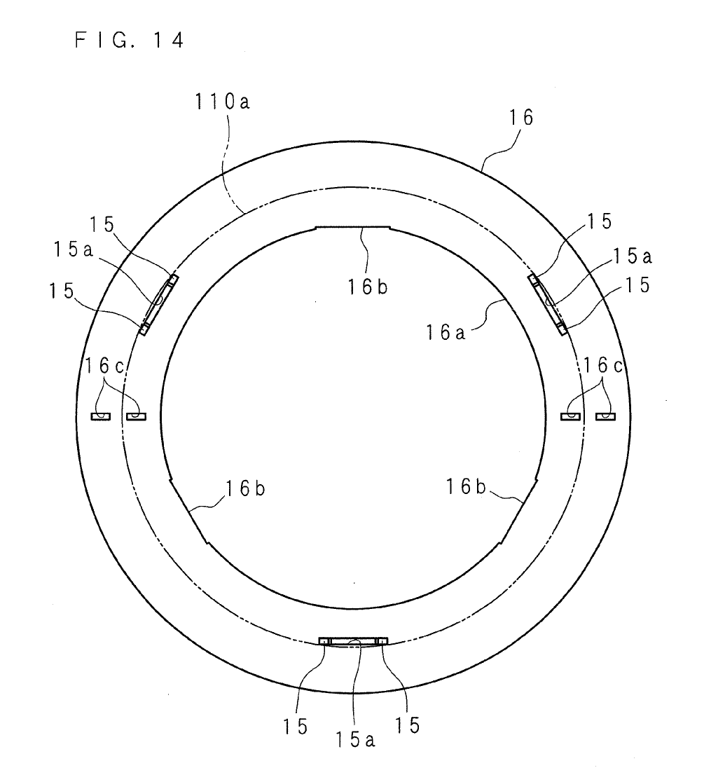

FIG. 13 is an exploded perspective view of a mounting assisting member 20 in accordance with an Embodiment 2 of the present invention. In the drawing, reference numeral 16 denotes a support frame. FIG. 14 is a schematic plan view of the support frame 16. In this case, a mounting hole 110a provided in the mounting member is shown by a two-dot chain line in FIG. 14.

The support frame 16 is formed as a disc shape having a circular opening 16a in the center, as shown in FIG. 14. Rectangular concave portions 16b, 16b, . . . are provided in an inner peripheral edge of the support frame 16 so as to be three uniformly arranged in a peripheral direction. In this case, a leaf spring corresponding to a mounting device of a mounted body is brought into contact with the concave portions 16b, 16b, . . . .

The support frame 16 is provided with pressing pieces 15, 15, . . . corresponding to an engagement portion so as to be uniformly arranged in the peripheral direction, respectively. The pressing pieces 15, 15, . . . are extended in a direction coming close to each other from two opposed sides of rectangular holes 15a, 15a, . . . provided so as to be uniformly arranged in the peripheral direction in such a manner as to be inscribed within the mounting hole 110a.

Further, slits 16c, 16c, . . . are provided in both sides while sandwiching the opening portion 16a therebetween so as to be in line in a radial direction. Since the other structures are the same as those of the Embodiment 1 shown in FIGS. 1 to 8, the same reference numerals are attached to the corresponding construction members, and a detailed description of the structure will be omitted.

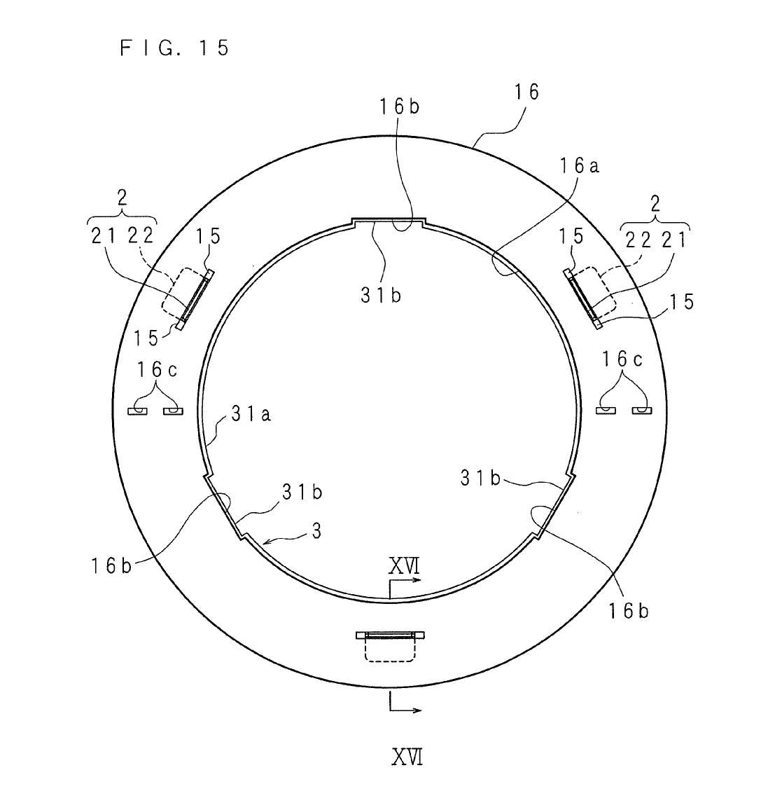

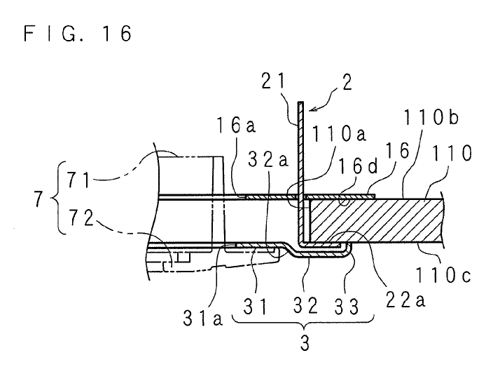

The mounting assisting member 20 structured as mentioned above is mounted to the mounting hole 110a provided in the ceiling 110 corresponding to the mounting member. FIG. 15 is a schematic plan view showing a mounted state of the mounting assisting member 20. FIG. 16 is a partly enlarged cross sectional view along a line XVI-XVI in FIG. 15. In this case, a cylinder portion 71 and a collar portion 72 of the frame 7 of the lighting apparatus 100 are shown by a two-dot chain line in FIG. 16.

The support frame 16 is supported to the mounting hole 110a by being inserted to the mounting hole 110a provided in the ceiling 110 from the other end side (the side of the lower surface 110c of he ceiling 110) in a state of being lightly bent with the slits 16c, 16c, . . . as a start, being thereafter turned back to the flat plate shape, and bringing one surface 16d corresponding to a contact surface of the support frame 16 into contact with a peripheral edge portion in one end side of the mounting hole 110a (a side of the upper surface 110b of the ceiling 110).

The holding devices 2, 2, . . . are pressed into the rectangular holes 15a, 15a, . . . of the support frame 16 from the side of the lower surface 110c of the ceiling 110 while setting the engagement plate portions 21, 21, . . . to an upper side, in the same manner as the mounting assisting member 10 in accordance with the Embodiment 1, in a state in which the support frame 16 is supported to the mounting hole 110a. As a result, the support frame 16 is supported in such a manner as to be prevented from coming off from the mounting hole 110a in a state in which the ceiling 110 is sandwiched by the holding devices 2, 2, . . . and the support frame 16.

On the other hand, the cover 3 is previously fitted to the mounted body. When the mounted body is inserted to the opening 16a of the support frame 16 so as to be mounted to the support frame 16, the cover 3 is brought into contact with the lower surface 110c of the ceiling 110 by the protrusion portion 33, as shown in FIG. 16.

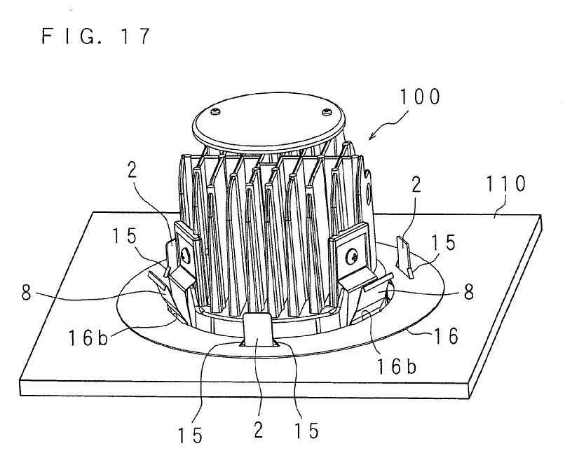

The mounting assisting member 20 is used so as to mount the lighting apparatus such as the down light or the like having an outside dimension which is appropriate for the smaller mounting hole 120a than the mounting hole 110a provided in the ceiling 110, in the same manner as the mounting assisting member 10 in accordance with the Embodiment 1. FIG. 17 is an outer appearance perspective view showing a mounted state of the lighting apparatus 100 which is mounted to the mounting hole 110a of the ceiling 110 by using the mounting assisting member 20 in accordance with the Embodiment 2. The lighting apparatus 100 is the same as the lighting apparatus 100 which is mentioned in the Embodiment 1, and a detailed description of the structure and an explanation of a procedure will be omitted. In this case, the lighting apparatus 100 is mounted to the mounting assisting member 20 in such a manner that the concave portions 16b, 16b, . . . provided in the support frame 16 come into line with the leaf springs 8, 8, . . . in their positions in the peripheral direction.

Since the mounting assisting member 20 is structured such that the support frame 16 is formed as a plate shape, one surface 16d of the support frame 16 comes into surface contact over an approximately whole periphery of the peripheral edge portion close to the upper surface 110b of the ceiling 110 of the mounting hole 110a. As a result, it is possible to lighten the influence of the concavity and convexity on the basis of a simple structure, even in the case that the concavity and convexity exists in the peripheral edge portion of the mounting hole 110a, and the case that the strength is lowered, and it is possible to stably support the lighting apparatus 100 for the smaller mounting hole 120a than the mounting hole 110a of the ceiling 110 to the ceiling 110 in a predetermined direction and by a predetermined support force.

In the case that the ceiling 110 corresponding to the mounting member is made of a comparatively brittle material such as a gypsum or the like, a force applied to the ceiling 110 from the lightening apparatus 100 acts on the peripheral edge portion of the mounting hole 110a via the mounting assisting member 20 so as to be approximately dispersed uniformly in the peripheral direction, by using the mounting assisting member 20 structured as mentioned above. Accordingly, it is possible to prevent the mounting hole 110a from being damaged, and the mounting assisting member 20 can be used as a reinforcing member of the mounting hole 110a.

Since the concave portions 16b, 16b, . . . are provided in the inner peripheral edge of the support frame 16, it is possible to easily position by engaging the leaf springs 8, 8, . . . provided in the lighting apparatus 100 in such a manner as to be mounted to the mounting hole 110a with the concave portions 16b, 16b, . . . , and it is possible to stably support the lighting apparatus 100 to the mounting assisting member 20.

Further, as mentioned above, since it is structured such that it can be inserted to the mounting hole 110a from the side of the lower surface 110c of the ceiling 110, it is possible to easily carry out a replacing work of the lighting apparatus 100.

Further, since the support frame 16 is formed as the tabular shape, it is possible to correspond even to the case that the thickness of the ceiling 110 is small (the case that the ceiling member is of one sheet construction of an aluminum or a stainless steel).

Since the engagement plate portion 21 of the holding devices 2, 2, . . . is engaged with the pressing pieces 15, 15, . . . provided in the support frame 16 from the side of the lower surface 110c of the ceiling 110 of the mounting hole 110a provided in the ceiling 110, it is possible to hold in such a manner as to prevent the support frame 16 from coming off from the mounting hole 110a while sandwiching the ceiling 110 by the holding devices 2, 2, . . . and the support frame 16. In this case, even if a force pulling the extension portion 22 of the holding device 2 downward is applied, the engagement between the pressing piece 15 and the engagement plate portion 21 of the holding device 2 is not released. In this case, the holding device 21 may be taken out downward while opening the pressing piece 15 in such a manner as to suppress the catch, by putting a hand therein from the mounting hole 110a at a time of demounting. Further, in the case of demounting the mounting assisting member 20, the leaf spring 8 comes off partway by first of all breaking open the portion with respect to the frame 7 from the connection portion (32a in FIG. 8) between the annular portion 32 of the cover 3 and the disc portion 31 thereof, and pulling down the frame 7 downward by putting a finger on the open gap. Next, the lighting apparatus 100 can be demounted together with the cover 3 by slowly taking out of the mounting hole 110a while bringing down the leaf spring 8 toward the radiator 4. In order to demount the support frame 16, the support frame 16 may be taken out of the mounting hole 110a by drawing out the holding device 2 while slightly opening in such a manner as to prevent the pressing piece 15 from being eaten into. Accordingly, it is possible to prevent the support frame 16 from coming off from the mounting hole 110a to the back side of the ceiling 110 at a time of mounting the lighting apparatus 100 to the ceiling 110. Since the support frame 16 is fixed on the basis of the engagement, any tool is not necessary, and a workability is good.

Further, since the gap between the mounting hole 110a and the lighting apparatus 100 is covered by the cover 3, it contributes to the beauty.

### Embodiment 3

The Embodiments 1 and 2 are structured such that the ceiling 110 is sandwiched by the holding device and the support frame of the mounting assisting member in order to prevent the support frame from coming off from the mounting hole 110a at a time of mounting the lighting apparatus, however, may be structured such that the ceiling 110 is sandwiched by the cover and the support frame by engaging the holding device and the support frame. A description will be given below of an example in which the latter structure is applied to the mounting assisting member having approximately the same construction as the mounting assisting member 20 in accordance with the Embodiment 2.

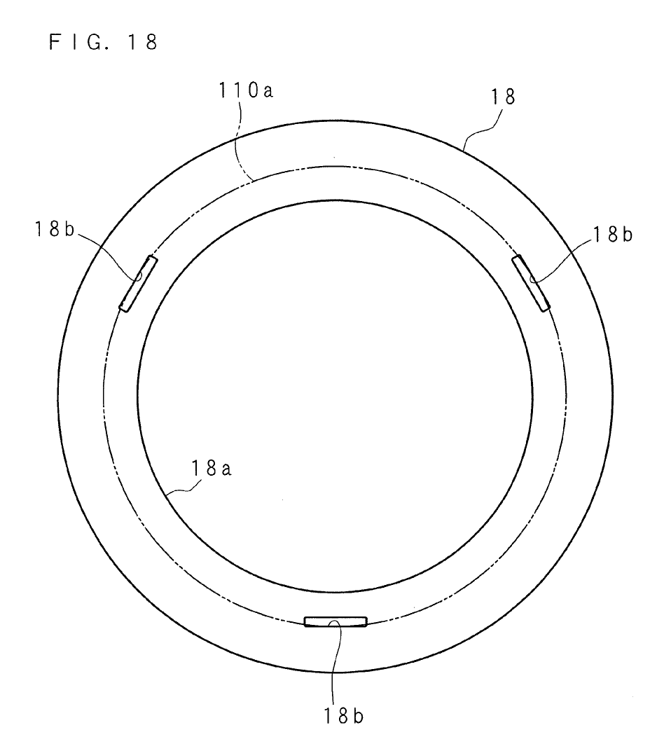

FIG. 18 is a schematic plan view of a support frame 18 of a mounting assisting member 30 in accordance with the present Embodiment 3. In this case, a mounting hole 110a provided in a mounting member is shown by a two-dot chain line in FIG. 18. The support frame 18 is formed as a disc shape having a circular opening 18a in the center, as shown in FIG. 18. The support frame 18 is provided with engagement holes 18b, 18b, . . . corresponding to an engagement portion so as to be uniformly arranged in a peripheral direction. In this case, the engagement holes 18b, 18b, . . . are formed in such a manner as to be positioned on a peripheral edge of the mounting hole 110a provided in the mounting member, as illustrated. Accordingly, it is possible to hold the support frame 18 in the mounting member so as to be concentric with the mounting hole 110a.

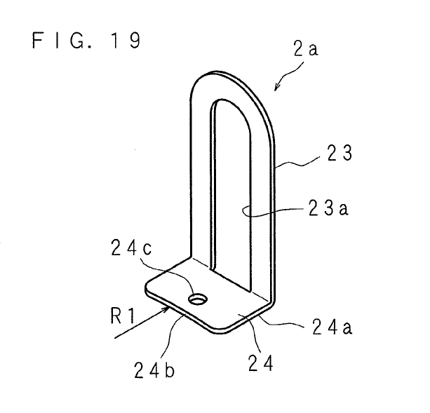

FIG. 19 is a schematic outer appearance perspective view of the holding device 2a. The holding device 2a is provided with an engagement plate portion 23 engaging with the engagement hole 18b of the support frame 18, and an approximately rectangular tabular extension portion 24 extended from one end of the engagement plate portion 23 in an orthogonal direction, and has an approximately L-shaped form. A long hole 23a is formed in the engagement plate portion 23, as shown in FIG. 19, and the engagement plate portion 23 has an approximately U-shaped form. Since the engagement plate portion 23 bored by the long hole 23a as mentioned above, the cover 3a can be mounted to the support frame 18 by inserting the engagement plate portion 23 of the holding device 2a to the mounting hole 110a and thereafter easily bending the engagement plate portion 23 in a thickness direction by a worker. Accordingly, a workability for mounting the mounting assisting member 30 is improved. Further, since a corner of an end portion of the engagement plate portion 23 is rounded, it is possible to smoothly insert the support frame 18 to the engagement hole 18b, it becomes easier to bend the engagement plate portion 23, and the workability for mounting the mounting assisting member 30 is further improved.

The extension portion 24 of the holding device 2a is formed in such a manner that an end edge in one side in a longitudinal direction of the holding device 2a extends along a predetermined radius R1. Further, a through hole 24c is provided in the extension portion 24.

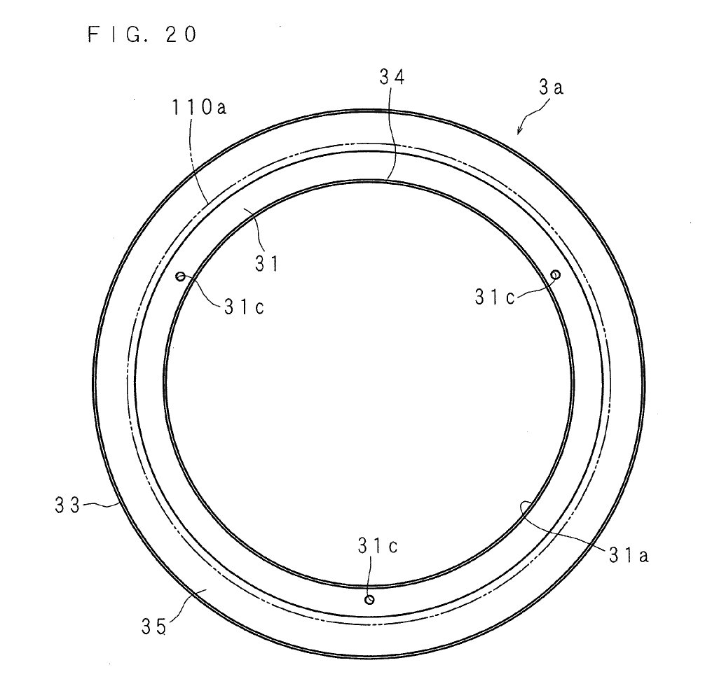

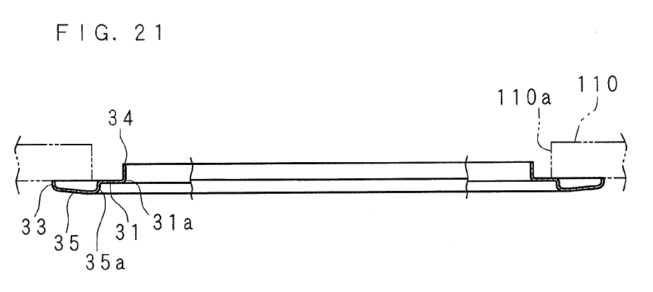

FIG. 20 is a schematic plan view of a cover 3a. FIG. 21 is a schematic side elevational view of the cover 3a, and shows a part thereof by a partial cross section. In this case, in the drawing, the mounting hole 110a provided in the mounting member 110 is shown by a two-dot chain line.

The cover 3a is provided with a disc portion 31 having a circular opening 31a in the center, a protruding portion 34 provided in a rising manner in an inner peripheral edge of the disc portion 31 over a whole periphery, an annular portion 35 provided so as to extend over a whole periphery in a radial direction from an outer peripheral edge of the disc portion 31, and a protruding portion 33 provided in a rising manner in an outer peripheral edge of the annular portion 35 over a whole periphery.

Through holes 31c, 31c, . . . are provided in the disc portion 31 so as to be uniformly arranged in a peripheral direction. The holding devices 2a, 2a, . . . mentioned above are fixed to the disc portion 31 at positions of the through holes 31c, 31c, . . . . In the extending portion 24 of the holding device 2a, the predetermined radius R1 is decided so as to approximately coincide with a radius of an outer periphery of the protruding portion 34, in such a manner that the end edge of the extending portion 24 comes into contact with an outer surface of the protruding portion 34 provided in an inner peripheral edge of the disc portion 31. Accordingly, it is possible to prevent the holding device 2a from rotating around a fixed position at a time of mounting the holding device 2a to the cover 3a, and a rotation prevention is not necessary. Since the protruding portions 34 and 33 are provided in the inner peripheral edge and the outer peripheral edge of the cover 3a, it is possible to make a rigidity of the cover 3a high, and a warping and a torsion are hard to be generated.

The annular portion 35 is formed as a tabular shape which is inclined slowly to the disc portion 31 from an inner side in a radial direction toward an outer side, and is structured such as to have a larger diameter than a diameter of the mounting hole 110a provided in the ceiling 110 corresponding to the mounting member, which is shown by a two-dot chain line in the drawing. The annular portion 35 and the disc portion 31 are connected by a connection portion 35a. In this case, a width of the annular portion 35 is appropriately decided in such a manner that the annular portion 35 covers the mounting member over an appropriate length in a radial direction from a peripheral edge end of the mounting hole 110a. Since the other structures are the same as those of the Embodiment 1, the same reference numerals are attached to the corresponding constructing members, and a detailed description of the structures will be omitted.

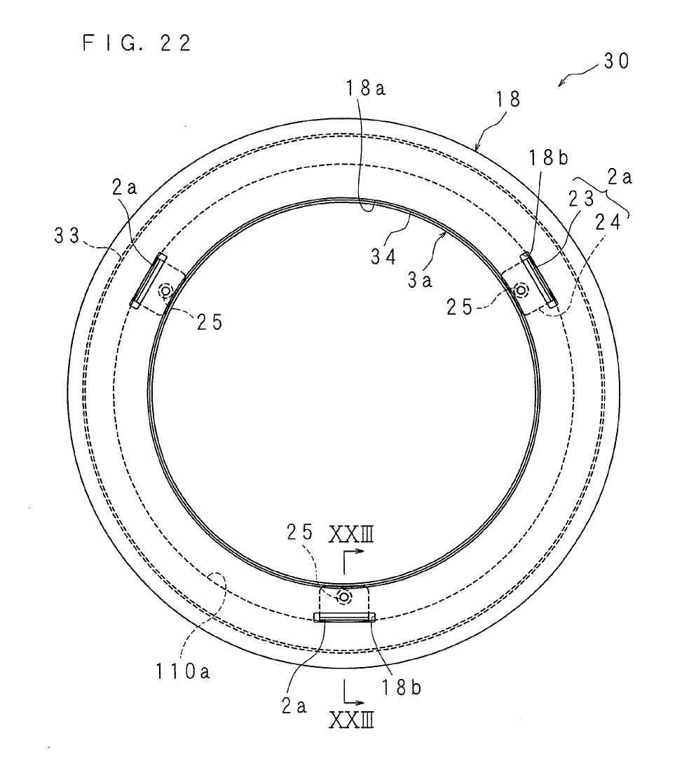

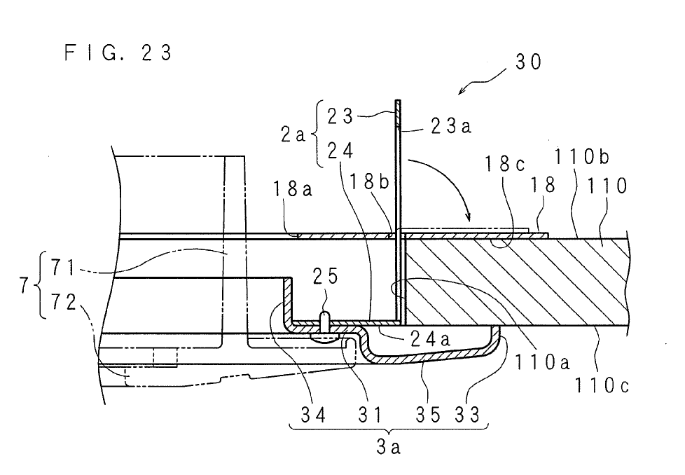

The mounting assisting member 30 structured as mentioned above is mounted to the mounting hole 110a provided in the ceiling 110 corresponding to the mounting member. FIG. 22 is a schematic plan view showing a mounted state of the mounting assisting member 30. FIG. 23 is a partly enlarged cross sectional view along a line XXIII-XXIII in FIG. 22. In this case, a cylinder portion 71 and a collar portion 72 of a frame 7 in the lighting apparatus 100 are shown by a two-dot chain line, in FIG. 23.

The support frame 18 is inserted to the mounting hole 110a provided in the ceiling 110 from the other end side (the side of the lower surface 110c of the ceiling 110) in a lightly bent state, is thereafter turned back to the flat plate shape, and is supported to the mounting hole 110a while bringing one surface 18c corresponding to a contact surface of the support frame 18 into contact with the peripheral edge portion in one end side of the mounting hole 110a (a side of the upper surface 110b of the ceiling 110).

The holding devices 2a, 2a, . . . are previously mounted to the cover 3a while bringing the one surfaces 24a, 24a, . . . of the extending portions 24, 24, . . . into contact with the disc portion 31 of the cover 3a. The holding devices 2a, 2a, . . . are previously integrated with the cover 3a, in a state in which an end edge of the extending portion 24 is brought into contact with an outer surface of a protruding portion 34 provided in an inner peripheral edge of the disc portion 31, by inserting and fixing the fixing devices 25, 25, . . . such as a rivet or the like to the through holes 24c, 24c, . . . , and 31c, 31c, . . . in a state in which the through holes 24c, 24c, . . . provided in the extending portions 24, 24, . . . are aligned with the through holes 31c, 31c, . . . provided in the disc portion 31 of the cover 3a. Here, in the present embodiment, the holding devices 2a, 2a, . . . are integrated with the cover 3a by using the fixing devices 25, 25, . . . , however, are not limited to this. They may be integrated in accordance with a bonding, or may be integrated on the basis of a locking by setting a locking means in the holding devices 2a, 2a, . . . and the cover 3a.

In a state in which the support frame 18 is supported to the mounting hole 110a, the cover 3a to which the holding devices 2a, 2a, . . . are fixed is moved upward from the side of the lower surface 110c of the ceiling 110, and the engagement plate portions 23, 23, . . . of the holding devices 2a, 2a, . . . are inserted to the engagement holes 18b, 18b, . . . of the support frame 18. In this state, the engagement plate portions 23, 23, . . . of the holding devices 2a, 2a, . . . are bent in a direction shown by an arrow in FIG. 23 until they come to a state shown by a two-dot chain line in the drawing. As a result, since the cover 3a and the support frame 18 are integrated by the holding devices 2a, 2a, . . . , the support frame 18 is supported in such a manner as to be prevented from coming off from the mounting hole 110a by sandwiching the ceiling 110 by the cover 3a and the support frame 18. In this case, the cover 3a is brought into contact with the lower surface 110c of the ceiling 110 by the protruding portion 33 as shown in FIG. 23, at a time of being mounted to the support frame 18.

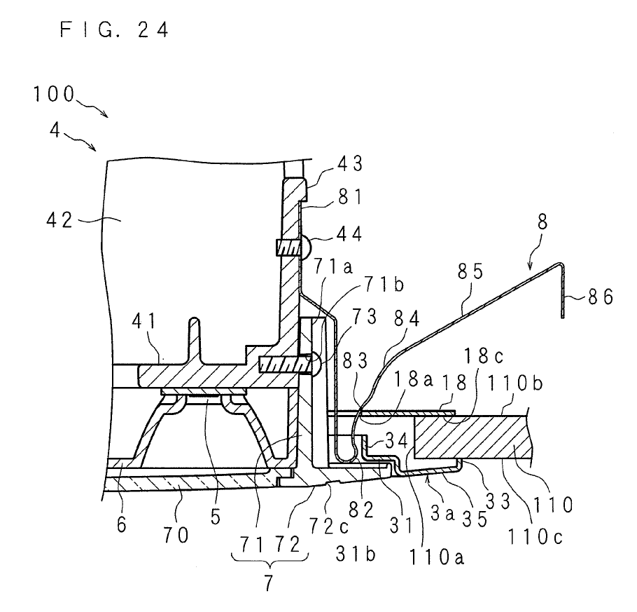

The mounting assisting member 30 is used so as to mount the lighting apparatus such as the down light or the like having an outside dimension which is appropriate for the smaller mounting hole than the mounting hole 110a provided in the ceiling 110, in the same manner as the mounting assisting members in accordance with the Embodiments 1 and 2. FIG. 24 is a partly cross sectional enlarged view showing a mounted state of the lighting apparatus 100 which is mounted to the mounting hole 110a of the ceiling 110 by using the mounting assisting member 30 in accordance with the Embodiment 3. The lighting apparatus 100 is the same as the lighting apparatus 100 which is mentioned in the Embodiments 1 and 2, and a detailed description of the structure and an explanation of a procedure will be omitted.

Since the mounting assisting member 30 is structured such that the support frame 18 is formed as a plate shape, one surface 18c of the support frame 18 comes into surface contact over an approximately whole periphery of the peripheral edge portion close to the upper surface 110b of the ceiling 110 of the mounting hole 110a. As a result, it is possible to lighten the influence of the concavity and convexity on the basis of a simple structure, even in the case that the concavity and convexity exists in the peripheral edge portion of the mounting hole 110a, and the case that the strength is lowered, and it is possible to stably support the lighting apparatus 100 for the smaller mounting hole 120a than the mounting hole 110a of the ceiling 110 to the ceiling 110 in a predetermined direction and by a predetermined support force.

In the case that the ceiling 110 corresponding to the mounting member is made of a comparatively brittle material such as a gypsum or the like, a force applied to the ceiling 110 from the lightening apparatus 100 acts on the peripheral edge portion of the mounting hole 110a via the mounting assisting member 30 so as to be approximately dispersed uniformly in the peripheral direction, by using the mounting assisting member 30 structured as mentioned above. Accordingly, it is possible to prevent the mounting hole 110a from being damaged, and the mounting assisting member 30 can be used as a reinforcing member of the mounting hole 110a.

Further, as mentioned above, since it is structured such that it can be inserted to the mounting hole 110a from the side of the lower surface 110c of the ceiling 110, it is possible to easily carry out a replacing work of the lighting apparatus 100.

Further, since the support frame 18 is formed as the tabular shape, it is possible to correspond even to the case that the thickness of the ceiling 110 is small (the case that the ceiling member is of one sheet construction of an aluminum or a stainless steel).

Since the engagement plate portions 23, 23, . . . of the holding devices 2a, 2a, . . . integrated with the cover 3a are inserted to the engagement holes 18b, 18b, . . . provided in the support frame 18, and are engaged with the engagement holes 18b, 18b, . . . by bending the engagement plate portions 23, 23, . . . , it is possible to hold in such a manner as to prevent the support frame 18 from coming off from the mounting hole 110a while sandwiching the ceiling 110 by the cover 3a and the support frame 18. In this case, even if a downward pulling force is applied to the cover 3a, the engagement between the engagement plate portion 23 and the engagement hole 18b is not released.

Further, in the case of demounting the mounting assisting member 30, the operation is achieved by first of all breaking open the portion with respect to the frame 7 from the connection portion (35a in FIG. 21) between the annular portion 35 of the cover 3a and the disc portion 31 thereof, and pulling down the frame 7 downward by putting a finger on the open gap. Accordingly, the leaf spring 8 comes off partway. Next, the lighting apparatus 100 can be demounted from the mounting hole 110a of the ceiling 110 by slowly taking out of the mounting hole 110a while bringing down the leaf spring 8 toward the radiator 4. Next, it is possible to demount the cover 3a and the holding devices 2a, 2a, . . . by putting a hand in from the mounting hole 110a, elongating the engagement plate portion 23 from a state shown by a two-dot chain line in FIG. 23 to a state shown by a solid line, and thereafter drawing downward together with the cover 3a. The support frame 18 can be demounted by inserting the mounting hole 110a in a state of lightly bending the support frame 18.

In accordance with the structure mentioned above, it is possible to prevent the support frame 18 from coming off from the mounting hole 110a to the back side of the ceiling 110 at a time of mounting the lighting apparatus 100 to the ceiling 110. Since the support frame 18 is fixed on the basis of the engagement, any tool is not necessary, and a workability is good. Further, the holding devices 2a, 2a, . . . are integrally provided in the cover 3a, it is possible to prevent the holding devices 2a, 2a, . . . from being lost during the work, and a workability is improved.

Further, since the gap between the mounting hole 110a and the lighting apparatus 100 is covered by the cover 3a, it contributes to the beauty.

Further, since the protruding portion 34 is provided in the inner peripheral edge of the cover 3a, it is possible to make a rigidity of the cover 3a high, and a warping and a torsion are hard to be generated. In addition, it is possible to prevent the bent portions 82, 82, . . . of the leaf springs 8, 8, . . . from moving on the cover 3a, at a time of mounting the lighting apparatus 100 to the ceiling 110, and it becomes easy to demount the lighting apparatus 100 from the mounting hole 110a of the ceiling 110.

In this case, it is possible to apply the structure in which the holding device is mounted to the cover, the holding device and the support frame are engaged, and the support frame is held in such a manner that it does not come off from the mounting hole 110a by sandwiching the ceiling by the cover and the support frame, such as the present embodiment, to the mounting assisting member 10 in accordance with the Embodiment 1.

In this case, in the Embodiments 2 and 3, the shape of the support frame is formed as the disc shape, however, is not limited to this, but may be formed as a rectangular plate shape or a polygonal plate shape.

In this case, in the embodiments mentioned above, the description is given of the example using three leaf springs corresponding to the mounting device of the lighting apparatus, however, the structure is not limited to this. Even in the case that the number of the leaf springs is two or four or more, it is possible to apply by appropriately setting the concave portions 14, 14, . . . of the support frame 1 and the concave portions 16b, 16b, . . . of the support frame 16, in correspondence to the number of the leaf springs.

Further, in the embodiments mentioned above, the description is given of the example which is applied to the lighting apparatus using the leaf spring as the mounting device, however, the structure is not limited to this, but it is possible to apply to a lighting apparatus of a type which is held to the ceiling on the basis of a point support such as a mounting adjuster disclosed in the Japanese Patent Application Laid-Open No. 2006-54100.

Further, in the embodiments mentioned above, the holding device used as the come-off prevention of the support frame is formed as the tabular shape having approximately the L-shaped form, however, is not limited to this, but may be formed as a shape capable of being engaged with the engagement portion of the support frame.

Further, in the embodiments mentioned above, the light source employs the LED modules 5, 5, . . . to which a plurality of LED elements are mounted, however, is not limited to this, but may employ an LED chip having a high intensity, an electro luminescence (EL), a fluorescent light, an electric lamp or the like.

Further, in the embodiment mentioned above, the description is given of the example in which the mounting assisting member is used for the down light, however, the mounting assisting member in accordance with the present invention can be applied to a rectangular lighting apparatus of the other type of straight shape or square shape, and the other equipment such as an air conditioning device or the like which is installed in the mounting member such as the ceiling or the like, than the lighting apparatus. In addition, it goes without saying that it is possible to execute in modes which are variously modified within the scope described in claims.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-13. (canceled)

14. A mounting assisting member used for mounting a mounted body for a smaller mounting hole than a mounting hole provided in a mounting member to the mounting hole, comprising:
a support frame supporting the mounted body and mounted to the mounting hole,
wherein the support frame has a contact surface supporting while dispersing a support force by bringing into contact with a peripheral edge portion of the mounting hole by a plane.

15. The mounting assisting member according to claim 14,
wherein the support frame is provided with a polygonal tubular base portion inscribed within the mounting hole, and is capable of mounting the mounted body for the smaller mounting hole than the mounting hole by inserting to a polygonal tube of the base portion so as to support.

16. The mounting assisting member according to claim 15,
wherein the base portion has a rectangular tabular shape which is bendable at a plurality of positions in a longitudinal direction, and
wherein the support frame is structured such as to keep the base portion in the polygonal tubular shape by being inserted to the mounting hole and thereafter fixing one side in the longitudinal direction of the base portion to the other side.

17. The mounting assisting member according to claim 16,
wherein the support frame is provided with an engagement hole which is provided in the one side of the support frame, and an engagement projection which is provided in the other side and engages with the engagement hole, and
wherein the base portion is kept in the polygonal tubular shape by engaging the engagement projection with the engagement hole.

18. The mounting assisting member according to claim 15,
wherein the base portion is formed as a hexagonal tubular shape.

19. The mounting assisting member according to claim 14,
wherein the support frame is formed as a tabular shape having an opening to which the mounted body is attached, and is structured such as to be capable of being inserted to the mounting hole.

20. The mounting assisting member according to claim 19,
wherein the support frame is provided with slits in both sides sandwiching the opening therebetween.

21. The mounting assisting member according to claim 14,
wherein the support frame is provided with a concave portion in an inner peripheral end edge.

22. The mounting assisting member according to claim 14, further comprising:
a cover covering a gap between the mounting hole and the mounted body.

23. The mounting assisting member according to claim 14, further comprising:
a holding device having a contact surface coming into contact with the peripheral edge portion of the mounting hole, and an engagement plate portion provided in a rising manner in the contact surface and engaging with the support frame;
wherein the support frame is provided with an engagement portion with which the engagement plate portion of the holding device engages.

24. The mounting assisting member according to claim 22, further comprising:
a holding device which is provided in the cover and has an engagement plate portion engaging with the support frame;
wherein the support frame is provided with an engagement portion with which the engagement plate portion of the holding device engages.

25. The mounting assisting member according to claim 23,
wherein the engagement portion is constructed by a pressing piece extended in a direction of coming close to each other from two opposed sides of a rectangular hole provided in the support frame.

26. A lighting apparatus comprising:
the mounting assisting member according to claim 14; and
a lighting apparatus main body mounted to a mounting member by the mounting assisting member.
